(19) United States
(12) Patent Application Publication
(10) Pub. No.: US 2006/0237500 A1
(43) Pub. Date: Oct. 26, 2006

(54) Side rail rack with removable base

(76) Inventor: Joseph J. Settelmayer, Fieldbrook, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/300,603

(22) Filed: Dec. 13, 2005

Related U.S. Application Data
(60) Provisional application No. 60/635,755, filed on Dec. 13, 2004.
(60) Provisional application No. 60/656,529, filed on Feb. 23, 2005.

(51) Int. Cl. B60R 9/00

(52) U.S. Cl. 224/325; 224/324

(57) ABSTRACT

A device for attaching a crossbar to a rail on top of a car includes a flexible strap or cable. The strap or cable is configured to at least partially encompass rails of various dimensions and straps.

### CROSS-REFERENCE TO RELATED APPLICATIONS

This application claims priority under 35 U.S.C. § 119(e) to U.S. Provisional Patent Application Ser. No. 60/635,755 entitled “Side Rail Rack with Removable Base,” filed Dec. 13, 2004 and Ser. No. 60/656,529 entitled “Side Rail Rack with Removable Base,” filed Feb. 23, 2005, the complete disclosures of which are hereby incorporated by reference for all purposes.

This application incorporates by reference in their entirety the following U.S. patents and PCT publication: U.S. Pat. Nos. 5,190,198; 5,715,980; 6,010,048; 6,305,589 and WO2004/076237.

### BACKGROUND

Top-mounted vehicle racks provide a versatile platform for transporting bicycles, skis, snowboards, boats, cargo boxes, gear racks, and other items. Such racks may include crossbars that extend side-to-side across the top of a vehicle. The crossbars typically are supported on each side of the vehicle's roof by a tower, where the length of each crossbar and the distance between crossbars depend on factors such as the shape and size of the vehicle's roof. The towers supporting the rack crossbars are securely fastened to the vehicle in some manner, to prevent the rack from slipping during use.

In the case of vehicles that do not have pre-installed rails on the roof of the vehicle (often referred to as a “factory rack”), the fastening mechanism may include clips that attach directly to the underside of the vehicle roof, where a window of the car meets the roof. The clips may be customized to fit a particular vehicle, while still allowing the doors of the vehicle to open and close normally with the rack installed.

In the case of vehicles that do have a preinstalled factory rack, the rack towers may be attached directly to the rails of the factory rack, avoiding any need to insert clips under the vehicle roof. Attachment of rack towers to a factory rack may, for example, be accomplished using clips or hooks that attach to the outer edge or underside of the rails, in a manner similar to attaching the towers directly to the vehicle roof.

Vehicle factory racks are manufactured in a wide variety of shapes and styles, and in some cases the rails of a factory rack may be provided with a groove or notch specifically designed for allowing attachment of a rack. The groove may be provided either on the inboard or the outboard side of the rail, and it may have a vehicle-specific shape or profile. Therefore, attachment of a tower to a groove in a factory rack rail may require a uniquely shaped clip mechanism and/or tower body. In some situations, a user may wish to move a rack from one vehicle equipped with a factory rack to another, where the rails on the two vehicles have differently shaped surfaces and/or attachment grooves.

Some rails provided with factory racks may not have an attachment groove, and may not be ideally suited for attachment of clips directly to the underside of the rail. For example, the shape of the rail may make it difficult for a clip to securely grip the rail without slipping. Therefore, existing vehicle rack systems may not be configured to be mounted easily on all vehicles equipped with a factory rack. In addition, it may be undesirable for a rack manufacturer to provide separate tower designs for every different make or model of car that uses a different factory rail configuration.

Thus, a need exists for a mechanism to securely attach rack towers to a vehicle equipped with factory rails, where the mechanism does not rely on the presence of a groove in the rails or on a particular rail shape, and where the crossbars and towers may be relatively easily separated and reconfigured for attachment to rails on a number of different vehicles.

### DETAILED DESCRIPTION

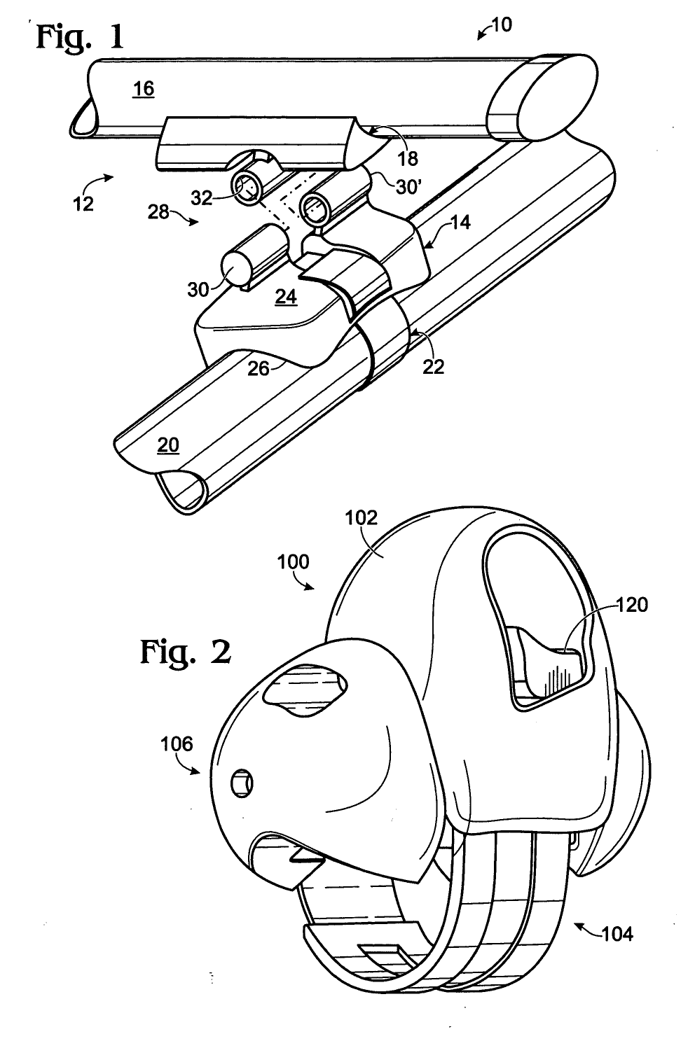

FIG. 1 shows various aspects of a first embodiment of a rack tower assembly 10 configured to be attached to a rail of a factory roof rack on a vehicle. As FIG. 1 indicates, tower assembly 10 includes a crossbar engagement portion 12, and a rail engagement portion 14. Crossbar engagement portion 12 may interface with a crossbar 16 in any suitable manner, for example by having an engagement slot 18 formed in the crossbar engagement portion (as depicted in FIG. 1), or through a hood arrangement that extends over the top of the crossbar and surrounds it. In some embodiments, the crossbar engagement portion may be unitarily formed with a hollow aperture through which the crossbar may slide.

Rail engagement portion 14 attaches to a rail 20 with a fastening device that at least partially conforms to the shape of the rail. In some embodiments, such as the embodiment depicted in FIG. 1, this fastening device may be a ratcheting strap 22 that may be tightened around the rail to secure the engagement portion to the rail. The strap is also attached to a body 24 of the rail engagement portion, for instance through a slot formed in the body through which the strap passes. Body 24 may include a contact surface 26 that is concave along at least one axis, to allow the body to frictionally engage a wide variety of rail shapes with at least two points of contact. Rail engagement portion 14 may thus contact rail 20 at three or more points (including the point of contact of strap 22), leading to three-point stability of the rail engagement portion where it attaches to the rail.

The rail engagement portion and/or the crossbar engagement portion also include an interface for attaching the rail and crossbar engagement portions to each other, thus securing the crossbar to the rail. This interface may be configured to allow rotation of the rail engagement portion on the rail, simplifying the installation process. For example, the embodiment depicted in FIG. 1 includes a three-part hinge mechanism 28, with two outer parts 30, 30′ of the hinge attached to the rail engagement portion, and an inner part 32 of the hinge attached to the crossbar engagement portion. The inner part of the hinge may be configured to fit between the two outer parts, and may be secured with a pin, a clamp, or any other suitable mechanism. The interface also may include a ball joint or other rotatable component configured to allow secure attachment of the rail engagement portion to the crossbar engagement portion.

FIGS. 2-6 show aspects of a second embodiment of a rack tower assembly 100 configured to be attached to a rail of a factory roof rack on a vehicle. FIG. 2 is a perspective view of assembly 100, showing a crossbar engagement portion 102, a rail engagement portion 104, and an interface 106 for attaching the crossbar engagement portion to the rail engagement portion. FIG. 3 is another perspective view of assembly 100, illustrating that interface 106 may be configured to allow crossbar engagement portion 102 to rotate with respect to rail engagement portion 104, to bring aperture 108 of the crossbar engagement portion into level alignment with a crossbar (not shown in FIG. 3).

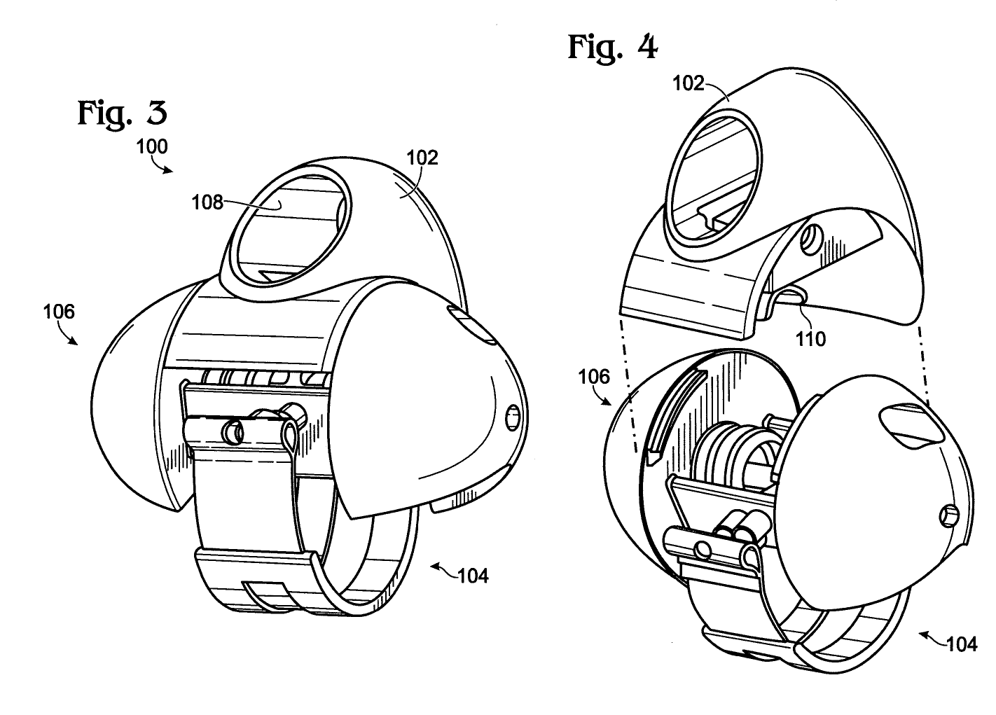

FIG. 4 is a partially exploded view of assembly 100, showing crossbar engagement portion 102 removed from rail engagement portion 104. In some embodiments, the crossbar engagement portion may include a cleat 110 that engages with interface 106, and that may be selectively rotatable with respect to the interface and selectively releasable from the interface.

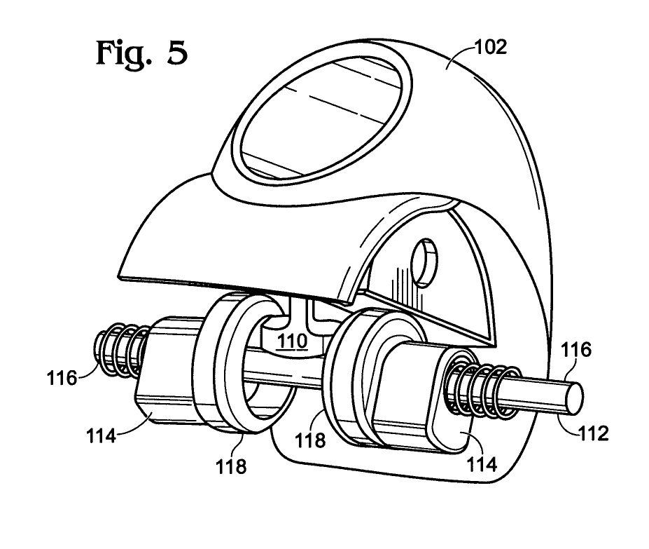

FIG. 5 is another partially exploded view showing cleat 110 of crossbar engagement portion 102 and a central portion of interface 106. The interface may include a central axle 112, a pair of hollow sleeves 114 that are slidably engaged with the axle, and a pair of springs 116 configured to supply inward tension to the hollow sleeves. When interface 106 is fully assembled, springs 116 cause sleeves 114 to overlap cleat 110, securely attaching the cleat to the interface.

As FIG. 5 depicts, sleeves 114 each also may include a sloped lead-in portion 118, so that when the crossbar engagement portion is lowered onto the interface, the cleat contacts the lead-in portions, forcing the sleeves outward and allowing the cleat to approach the axle. Once the cleat passes the lead-in portions, the springs may cause the sleeves to “snap” back into place so as to securely engage the cleat. To release the cleat—and thus to disengage the crossbar engagement portion from the interface—the hollow sleeves may be spread apart by any suitable mechanism, far enough so that they no longer ovelap the cleat and the cleat may be freely lifted off the axle.

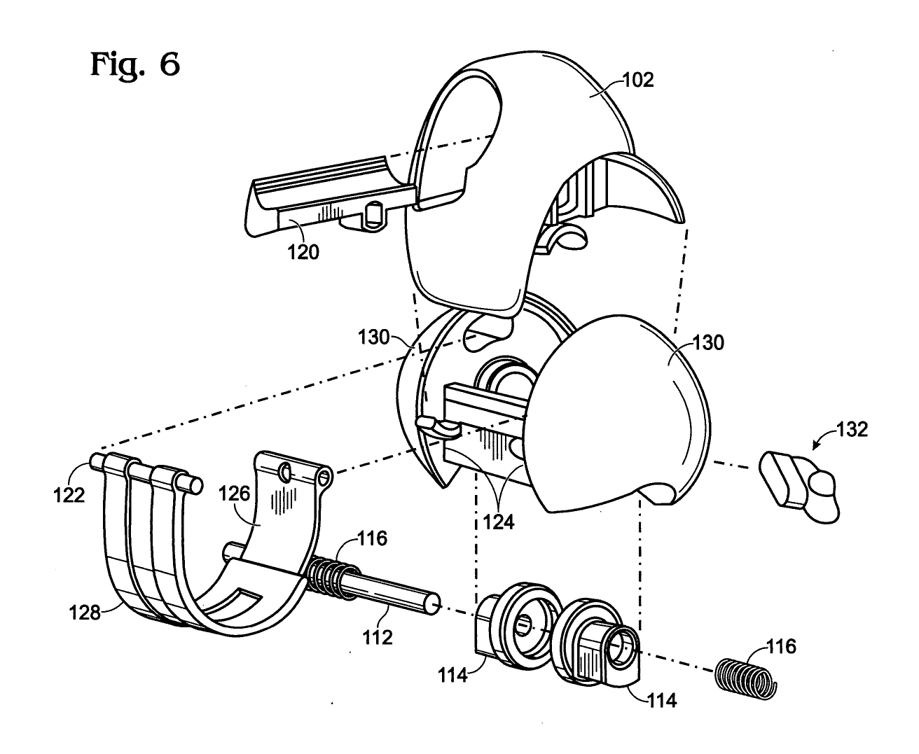

FIG. 6 is yet another partially exploded view of assembly 100, showing further details of this embodiment of the invention. As depicted in FIG. 6, crossbar engagement portion 102 may include a selectively removable wedge 120. When wedge 120 is removed from the crossbar engagement portion, the crossbar engagement portion may be configured to engage a square or rectangular crossbar, whereas when wedge 120 is inserted into the crossbar engagement portion, the crossbar engagement portion may be configured to engage a rounded crossbar.

FIG. 6 also shows rail engagement portion 104, including a pin 122 for engaging a pair of sloped pin receptors 124 of the interface, and a tightening mechanism 126 for tightening the rail engagement portion around a rail (not shown), for example by increasing tension in a strap 128 through ratcheting, or in any other suitable manner. The interface also may include a pair of outer covers 130 that may be configured to attach to axle 112 and sleeves 114, to hold springs 116 under tension as previously described. Finally, FIG. 6 shows a release mechanism 132 configured to spread sleeves 114 apart sufficiently to release crossbar engagement portion 102 from interface 106. The release mechanism may, for example, be disposed between the sleeves in a manner such that when rotated, it forces the sleeves apart and releases cleat 110 from axle 112.

Many variations of the devices described above are possible. Cables may be substituted for straps in any of the examples described above. The same types of assemblies including flexible straps or cables may be used to attach cargo specific accessories to crossbars of various shapes and sizes. For example, a flexible strap or cable may be used to attach a ski mount or bike mount to crossbars of many different shapes and sizes. Various alternative types of tightening mechanisms may also be used.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification, or variance.

I claim:

1. A tower assembly for detachably mounting a transversely extending crossbar to a longitudinally extending rail of a vehicle-mounted roof rack comprising:
a crossbar engagement portion configured to securely engage the crossbar;
a rail engagement portion including a fastening device that at least partially conforms to the shape of the rail, the fastening device configured to securely engage the rail; and
an interface portion for attaching the crossbar engagement portion to the rail engagement portion.

2. The tower assembly of claim 1, wherein the fastening device includes an adjustable strap.

3. The tower assembly of claim 1, wherein the fastening device includes a flexible cable.

4. The tower assembly of claim 3, wherein the flexible cable has a protective cover.

5. The tower assembly of claim 2, wherein the adjustable strap includes a ratcheting mechanism for tightening the strap around the rail.

6. The tower assembly of claim 1, wherein the interface portion is configured to allow rotation between the crossbar engagement portion and the rail engagement portion.

7. The tower assembly of claim 6, wherein the interface portion includes a hinge mechanism.

8. The tower assembly of claim 6, wherein the interface portion includes a ball joint.

9. The tower assembly of claim 1, wherein the rail engagement portion is configured to contact the rail at three or more points on the rail.

10. The tower assembly of claim 1, wherein the rail engagement portion includes a body having a contact surface for contacting the rail, and wherein the contact surface is concave along at least one axis.

11. The tower assembly of claim 10, wherein the contact surface is concave along two axes.

12. The tower assembly of claim 10, wherein the fastening device is an adjustable strap and wherein a slot is formed in the body for engaging the strap.
